(19) United States
(12) Patent Application Publication
(10) Pub. No.: US 2024/0240632 A1
(43) Pub. Date: Jul. 18, 2024

(54) SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP

(71) Applicant: BJ Energy Solutions, LLC, The Woodlands, TX (US)

(72) Inventors: Tony Yeung, The Woodlands, TX (US); Ricardo Rodriguez-Ramon, The Woodlands, TX (US); Guillermo Rodriguez, The Woodlands, TX (US); Samir Nath Seth, The Woodlands, TX (US)

(73) Assignee: BJ Energy Solutions, LLC, The Woodlands, TX (US)

(21) Appl. No.: 18/618,827

(22) Filed: Mar. 27, 2024

Related U.S. Application Data
(63) Continuation of application No. 18/202,115, filed on May 25, 2023, now Pat. No. 11,971,028.
Application No. 18/202,115 is a continuation of application No. 18/108,821, filed on Feb. 13, 2023.
Application No. 18/108,821 is a continuation of application No. 17/585,766, filed on Jan. 27, 2022, now Pat. No. 11,719,234.
Application No. 17/585,766 is a continuation of application No. 17/469,970, filed on Sep. 9, 2021, now Pat. No. 11,280,331.
Application No. 17/469,970 is a continuation of application No. 17/363,151, filed on Jun. 30, 2021, now Pat. No. 11,149,726.
Application No. 17/363,151 is a continuation of application No. 17/213,562, filed on Mar. 26, 2021, now Pat. No. 11,092,152.
Application No. 17/213,562 is a continuation of application No. 16/948,291, filed on Sep. 11, 2020, now Pat. No. 11,015,594.
(60) Provisional application No. 62/704,560, filed on May 15, 2020.
(60) Provisional application No. 62/899,963, filed on Sep. 13, 2019.

(51) Int. Cl. F04B 53/00; F04B 17/00; F16F 15/12; F16F 15/14; F16F 15/315

(52) U.S. Cl. CPC F04B 53/003; F04B 17/00; F16F 15/1202; F16F 15/1457; F16F 15/3153

(57) ABSTRACT

A pump system may include a pump, a driveshaft, driving equipment, and a vibration dampening assembly configured to reduce pump-imposed high frequency/low amplitude and low frequency/high amplitude torsional vibrations. The pump may have an input shaft connected to the driveshaft. The driving equipment may include an output shaft having an output flange connected to the driveshaft. The driving equipment may be configured to rotate the driveshaft to rotate the input shaft of the pump therewith. The vibration dampening assembly may include one or more flywheels operably connected to the input shaft and configured to rotate therewith.

### PRIORITY CLAIMS

This is a continuation of U.S. Non-Provisional application Ser. No. 18/202,115, filed May 25, 2023, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” which is a continuation of U.S. Non-Provisional application Ser. No. 18/108,821, filed Feb. 13, 2023, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” which is a continuation of U.S. Non-Provisional application Ser. No. 17/585,766, filed Jan. 27, 2022, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” now U.S. Pat. No. 11,719,234, issued Aug. 8, 2023, which is a continuation of U.S. Non-Provisional application Ser. No. 17/469,970, filed Sep. 9, 2021, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” now U.S. Pat. No. 11,280,331, issued Mar. 22, 2022, which is a continuation of U.S. Non-Provisional application Ser. No. 17/363,151, filed Jun. 30, 2021, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” now U.S. Pat. No. 11,149,726, issued Oct. 19, 2021, which is a continuation of U.S. Non-Provisional application Ser. No. 17/213,562, filed Mar. 26, 2021, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” now U.S. Pat. No. 11,092,152, issued Aug. 17, 2021, which is a continuation of U.S. Non-Provisional application Ser. No. 16/948,291, filed Sep. 11, 2020, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” now U.S. Pat. No. 11,015,594, issued May 25, 2021, which claims priority to and the benefit of U.S. Provisional Application No. 62/704,560, filed May 15, 2020, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” and U.S. Provisional Application No. 62/899,963, filed Sep. 13, 2019, titled “USE OF SINGLE MASS FLYWHEEL ALONGSIDE TORSIONAL VIBRATION DAMPER SYSTEM FOR SINGLE ACTING RECIPROCATING PUMP,” the disclosures of which are incorporated herein by reference in their entireties.

### BACKGROUND

### Technical Field

The present disclosure relates to single acting reciprocating pumps and, more specifically, to single mass flywheels and torsional vibration dampers for use with single acting reciprocating pumps.

### Discussion of Related Art

During fracturing operations, high and low frequency torsional vibration is a common occurrence through the driveline. Such torsional vibration is typically generated via the operation of a reciprocating pump. Reciprocating pumps are driven to pump “slugs” of fluid with as the pump reciprocates or cycles. The speed and operating pressure of the pump influences the amount of fluid pumped downstream of the pump. As the reciprocating pump is cycled, movement of the slugs create pressure fluctuations within fluid downstream of the pump. This pressure fluctuation may create “hydraulic fluid pulsation” within the pump that is added to the operating pressure of the pump. The hydraulic fluid pulsation may be transferred upstream to driving equipment used to drive the pump in the form of torque output variances. The driving equipment may include one or more components including, but not limited to, a driveshaft, an engine, a transmission, or a gearbox.

As noted, the nature of the suction and discharge strokes of the reciprocating pump generate variable torque spikes that originate from the discharge of high pressure fluid and may migrate through the drive line and cause damage and premature wear on the driveline components including the prime mover. Problematically, each reciprocating pumps operating in the field generally have their own torsional vibration frequency and amplitude profile that is dependent upon the selected operational pressure and rate. Another problem arises when a group of reciprocating pumps are connected to a common discharge line. In this operational scenario, reciprocating pumps may begin to synchronize such that the natural sinusoidal wave form of one pump will begin to mirror that of another pump from the group, which promotes pressure spikes and torsional distortion of even higher amplitude to pulsate through the drive lines.

The torque output variances may create shock loading in the pump and in the driving equipment upstream from the pump. This shock loading may shorten the life of the driving equipment including causing failure of one or more components of the driving equipment. In addition, driving equipment such as combustion engines, e.g., gas turbine engines, have a movement of inertia, natural damping effects, and stiffness coefficients. Some driving equipment may have low natural damping effects that may allow for torsional resonance interaction within the driving equipment and/or between the driving equipment and the pump. This torsional resonance may shorten the life of the driving equipment including causing failure of one or more components of the driving equipment.

Thus there is a need to provide protection of hydraulic drive line fracturing equipment from imposed high frequency/low amplitude and low frequency/high amplitude torsional vibrations.

### SUMMARY

This disclosure relates generally to vibration dampening assemblies for use with pump systems including a reciprocating pump and driving equipment configured to cycle the pump. The vibration dampening assemblies may include single mass flywheel(s) and/or torsional vibration dampener(s) to reduce or eliminate upstream shock loading and/or dampen torsional resonance from reaching the driving equipment; i.e., to reduce or eliminate pump imposed high frequency/low amplitude and low frequency/high amplitude torsional vibrations.

According to some embodiments, a single mass flywheel or a series of single mass flywheels along the drive-train system components between the gear box or transmission and input shaft of a reciprocating pump may be used to reduce output speed fluctuations that may cause vibrational and torsional effects on the gearbox and engine. Further, at least one torsional vibration dampener may be connected to the drive-train system to dampen the harmonic effects of the reciprocating pump. According to some embodiments, the at least one flywheel and the at least one torsional damper may not require electrical control to be able to function, but it is contemplated that electrical sensors and instrumentation may be present to monitor the condition of the drive line.

According to some embodiments, a pump system may include a pump, a driveshaft, driving equipment, and a vibration dampening assembly. The pump may have an input shaft that is connected to the driveshaft. The driving equipment may include an output shaft that has an output flange connected to the driveshaft. The driving equipment may be configured to rotate the driveshaft to rotate the input shaft of the pump therewith. The vibration dampening assembly may include at least one flywheel that is operably connected to the input shaft and is configured to rotate therewith. The input shaft may include an input flange that is connected to the driveshaft. According to some embodiments, the at least one flywheel may comprise a first flywheel.

According to some embodiments, the pump may be a single acting reciprocating pump. The first flywheel may be a single mass flywheel. The first flywheel may be connected to the output flange of the driving equipment or the first flywheel may be connected to the input flange of the single acting reciprocating pump.

In some embodiments, the vibration dampening assembly may include at least one torsional vibration damper that is operably connected to the input shaft. According to some embodiments, the at least one torsional vibration damper may comprise a first torsional vibration damper that may be connected to the input flange of the pump, may be connected to the output flange of the driving equipment, and/or may be connected to the first flywheel.

According to some embodiments, the first flywheel may be connected to the output flange of the driving equipment and the first torsional vibration damper may be connected to the first flywheel. The vibration dampening assembly may include a second torsional vibration damper that may be connected to the input flange.

According to some embodiments, the vibration damping system may include a second flywheel that may be connected to the input flange. The second torsional vibration damper may be connected to the second flywheel.

According to some embodiments, the first and/or the second flywheel may be configured to absorb a torque shock in the form of torque variance resulting from hydraulic fluid pulsation within the pump. The first and/or second torsional vibration damper may be configured to reduce torsional resonance within the driving equipment or the pump.

According to some embodiments, a method of sizing a flywheel for a pump system that has a single acting reciprocating pump and driving equipment configured to cycle the pump may include calculating a desired moment of inertia of the flywheel and sizing the flywheel to have the desired moment of inertia. The desired moment of inertia may be calculated using a kinetic energy “KE” of a torque variance within the pump system above a nominal torque of the pump system that results from hydraulic fluid pulsation within the pump.

In some embodiments, calculating the desired moment of inertia of the flywheel may include calculating a first desired moment of inertia of a first flywheel from a first portion of the kinetic energy “KE” of the torque variance within the pump system as a result of hydraulic fluid pulsation within the pump, and calculating a second desired moment of inertia of a second flywheel from a second portion of the kinetic energy “KE” of the torque variance within the pump system as a result of hydraulic fluid pulsation within the pump. The first portion may be greater than, lesser than, or equal to the second portion. Sizing the flywheel may include sizing the first flywheel to have the first desired moment of inertia and sizing the second flywheel to have the second desired moment of inertia.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Accordingly, these and other objects, along with advantages and features of the present disclosure herein disclosed, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than may be necessary for a fundamental understanding of the exemplary embodiments discussed herein and the various ways in which they may be practiced. According to common practice, the various features of the drawings discussed below are not necessarily drawn to scale. Dimensions of various features and elements in the drawings may be expanded or reduced to more clearly illustrate the embodiments of the disclosure.

FIG. 1 is a schematic view of a pump system having a first exemplary embodiment of a vibration dampening assembly provided according to an embodiment of the disclosure.

FIG. 2 is a graph illustrating a pressure, acceleration, and suction pressure of an exemplary pump of the pump system of FIG. 1 through a cycle of the pump according to an embodiment of the disclosure.

FIG. 3 is a schematic front view of a flywheel of the pump system of FIG. 1 according to an embodiment of the disclosure.

FIG. 4 is a schematic side view of the flywheel of the pump system of FIG. 3 according to an embodiment of the disclosure.

FIG. 5 is a table providing exemplary properties of flywheels that each have the same moment of inertia.

FIG. 6 is another schematic front view of a flywheel of the pump system of FIG. 1 illustrating bolt holes and rotational stresses of the flywheel according to an embodiment of the disclosure.

FIG. 7 is a graph illustrating tangential and radial stresses of the flywheel of FIG. 1 according to an embodiment of the disclosure.

FIG. 8 is a schematic side view of a portion of the pump system of FIG. 1 illustrating a bolt and nut securing the flywheel to an output flange according to an embodiment of the disclosure.

FIG. 9 is a schematic view of the pump system of FIG. 1 with another exemplary embodiment of a vibration dampening assembly according to an embodiment of the disclosure.

FIG. 10 is a schematic view of the pump system of FIG. 1 with another exemplary embodiment of a vibration dampening assembly according to an embodiment of the disclosure.

FIG. 11 is a schematic view of the pump system of FIG. 1 with another exemplary embodiment of a vibration dampening assembly according to an embodiment of the disclosure.

FIG. 12 is a graph showing torsional vibration analysis data results demonstrating the reduction in synthesis and torque spikes with the use of a torsional vibration dampener (TVD) and a single mass produced by a pump system such as shown in FIG. 1 according to an embodiment of the disclosure.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect may be combined with features from any other embodiment or aspect in any appropriate combination. For example, any individual or collective features of method aspects or embodiments may be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements.

As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

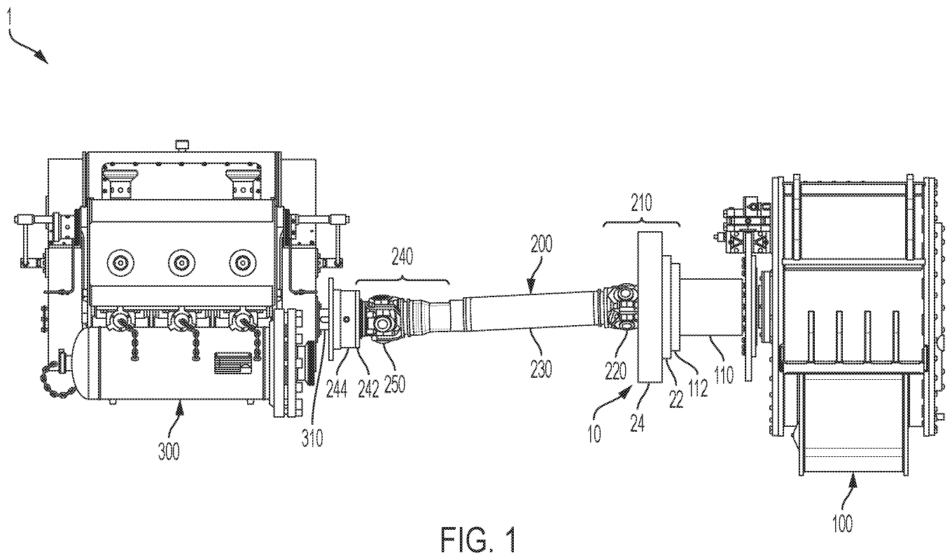

Referring now to FIG. 1, an exemplary pump system 1 having a vibration dampening assembly 10 described in accordance with the present disclosure. The pump system 1 includes driving equipment 100 and driven components including a driveshaft 200 and a pump 300. The vibration dampening assembly 10 is secured to portions of a pump system 1 between the driving equipment 100 and the pump 300 to dampen upstream high frequency/low amplitude and low frequency/high amplitude torsional vibrations generated by the operating pump 300 from reaching the driving equipment 100.

The driving equipment 100 is illustrated as a power transfer case. In some embodiments, the driving equipment 100 includes a driveshaft, a transmission, a gearbox, or an engine, e.g., an internal combustion engine or a gas turbine engine. The driving equipment 100 includes an output shaft 110 that has an output flange 112. The driving equipment 100 is configured to rotate the output shaft 110 about a longitudinal axis thereof. The driving equipment 100 may include an engine and a transmission, gearbox, and/or power transfer case that may be configured to increase a torque and decrease a rotational speed of the output shaft 110 relative to a driveshaft of the engine or that may be configured to decrease a torque and increase a rotational speed of the output shaft 110 relative to a driveshaft of the engine. The pump 300 includes in input shaft 310 having an input flange that is configure to receive input from the driving equipment 100 in the form of rotation of the input flange about a longitudinal axis of the input shaft 310.

The driveshaft 200 has a driving or upstream portion 210, a driven or downstream portion 240, and a central portion 230 between the upstream and downstream portions 210, 240. The upstream portion 210 includes an upstream flange (not shown) that is connected to the output flange 112 of the driving equipment 100 such that the upstream portion 210 rotates in response or in concert with rotation of the output shaft 110. The central portion 230 is secured to the upstream portion 210 and rotates in concert therewith. The downstream portion 240 is secured to the central portion 230 and rotates in concert therewith. The downstream portion 240 includes a downstream flange 242 that is connected to an input flange of the pump 300 such that the input flange rotates in response or in concert with rotation of the driveshaft 200. The downstream portion 240 may also include a spindle 244 adjacent the downstream flange 242. The upstream flange (not shown) may be similar to downstream flange 242 and the upstream portion 210 may include a spindle (not shown) that is similar to the spindle 244 of the downstream portion 240.

In some embodiments, the output shaft 110 of the driving equipment 100 is offset from the input shaft 310 of the pump 300 such that the longitudinal axis of the output shaft 110 is out of alignment, i.e., not coaxial with, the longitudinal axis of the input shaft 310. In such embodiments, the upstream portion 210 or the downstream portion 240 may include a constant velocity (CV) joint 220, 250 between the spindle 244 and the central portion 230. The CV joints 220, 250 allow for the output shaft 110 to be operably connected to the input shaft 310 when the output and input shafts 110, 310 are offset from one another.

During operation, the output shaft 110 is rotated by the driving equipment 100 to rotate the input shaft 310 of the pump 300 such that the pump 300 is driven to pump slugs of fluid. Specifically, the driving equipment 100 is configured to rotate the input shaft 310 at a constant velocity such that the pump 300 provides a constant flow of fluid. As the pump 300 pumps slugs of fluid, the pulses of the slugs of fluid create a pulsation pressure that adds to the nominal operating pressure of the pump 300.

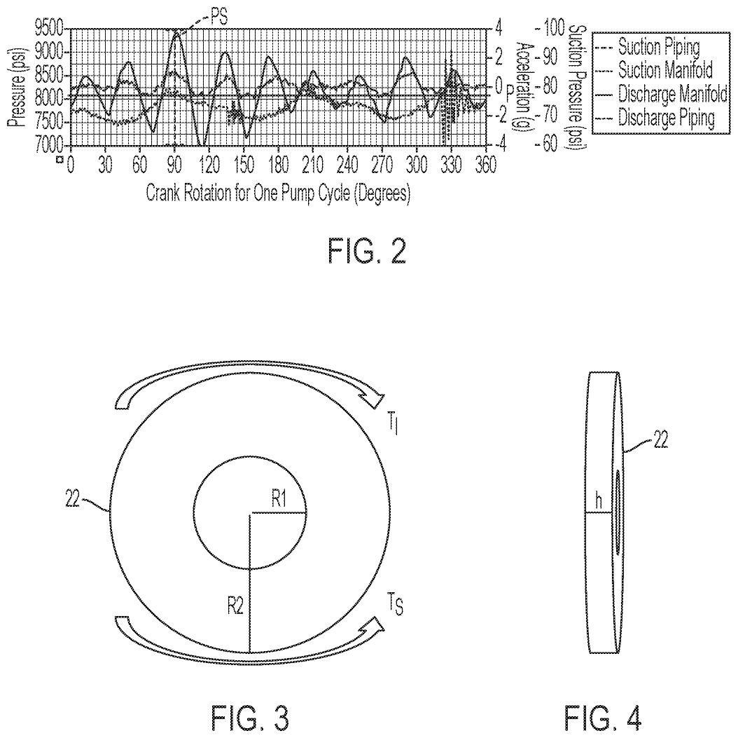

With additional reference to FIG. 2, the pressure P of the pump 300 is illustrated through an exemplary cycle of the pump 300. The pump 300 has a nominal pressure PN of 8250 psi with a normal operating pressure in a range of 7500 psi to 9000 psi. The pulsations of the operating pressure illustrate the pulsation pressure described above which is known as “hydraulic fluid pulsation.” This hydraulic fluid pulsation may lead to pressure spikes P_{S} as illustrated between points 60 and 150 of the cycle of the pump 300 in FIG. 2. The pressure spikes P_{S} are measured as peak to peak pressure variations, which as shown in FIG. 2 is 2,500 psi.

The hydraulic fluid pulsation describe above may be transferred upstream from the pump 300 to the driving equipment 100 through the driveshaft 200. Specifically, the hydraulic fluid pulsation results in torque variations in a crank/pinion mechanism of the pump 300 that are transferred upstream as torque output variations at the input shaft 310 of the pump 300. These torque output variations may create a torsional shock T_{S} at the output flange 112 of the output shaft 110. A single large torsional shock T_{S} may damage components of the driving equipment 100. In addition, an accumulation of minor or small torsional shocks T_{S} may decrease a service life of one or more of the components of the driving equipment 100.

With continued reference to FIG. 1, the vibration dampening assembly 10 is provided to reduce the transfer of the torsional shock T_{S} upstream to the driving equipment 100. The vibration dampening assembly 10 may include at least one flywheel. In one aspect, the at least one flywheel may comprise a flywheel 22 that is connected to the output flange 112 and disposed about the upstream portion 210 of the driveshaft 200. In some embodiments, the flywheel 22 may be connected to the output flange 112 and be disposed about the output shaft 110.

As the output shaft 110 rotates the driveshaft 200, the flywheel 22 rotates in concert with the output shaft 110. As shown in FIG. 3, torque provided by the driving equipment 100 to the input shaft 310 of the pump 300 is illustrated as an input torque T_{I} and the torque output variations at the input shaft 310 of the pump 300 result in a reaction torque illustrated as torque spikes T_{S}. As the flywheel 22 rotates, angular momentum of the flywheel 22 counteracts a portion of or the entire torque output variances and reduces or eliminates torsional shock T_{S} from being transmitted upstream to the driving equipment 100. Incorporation of the flywheel 22 into the vibration dampening assembly 10 allows for the vibration dampening assembly 10 to dampen the low frequency, high amplitude torsional vibrations imposed on the drivetrain system that is caused by the hydraulic fluid pulsation.

The angular momentum of the flywheel 22 may be calculated as a rotational kinetic energy “KE” of the flywheel 22. The “KE” of the flywheel 22 may be used to absorb or eliminate a percentage of the torsional shock T_{S}. The “KE” of the flywheel 22 is a function of the moment of inertia “I” of the flywheel 22 and the angular velocity “w” of the flywheel 22 which may be expressed as:

$$K E = \frac{1}{2} {( I ω )}^{2} \qquad ( 1 )$$

As noted above, the driving equipment 100 is configured to rotate at a constant angular velocity “ω” such that with a known “KE” or a known moment of inertia “I” the other of the “KE” or the moment of inertia “I” may be calculated. In addition, the moment of inertia “I” of the flywheel 22 is dependent on the mass “m” and the radial dimensions of the flywheel 22 and may be expressed as:

$$I = \frac{m ( {r}_{1}^{2} + {r}_{2}^{2} )}{2} \qquad ( 2 )$$

where r₁ is a radius of rotation and r₂ is a flywheel radius as shown in FIG. 3. This equation assumes that the flywheel 22 is formed of a material having a uniform distribution of mass. In some embodiments, the flywheel 22 may have a non-uniform distribution of mass where the mass is concentrated away from the center of rotation to increase a moment of inertia “I” of the flywheel 22 for a given mass. It will be appreciated that the mass may be varied for a given a radius of rotation r₁ and a given a flywheel radius r₂ by varying a thickness “h” of the flywheel 22 in a direction parallel an axis of rotation of the flywheel 22 as shown in FIG. 4.

The dimensions and mass of the flywheel 22 may be sized such that the flywheel 22 has a “KE” similar to a “KE” of an anticipated torque variance above a nominal operating torque of the pump 300. In some embodiments, the flywheel 22 maybe sized such that the “KE” of the flywheel 22 is greater than an anticipated torque variance such that the flywheel has a “KE” greater than any anticipated torque variance and in other embodiments, the flywheel 22 may be sized such that the “KE” of the flywheel 22 is less than the anticipated torque variance such that the flywheel 22 is provided to absorb or negate only a portion of the anticipated torque variances. In particular embodiments, the flywheel 22 is sized such that the “KE” of the flywheel 22 is equal to the anticipated torque variance such that the flywheel 22 is provided to absorb or negate the anticipated torque variance while minimizing a moment of inertia “I” of the flywheel 22.

The rotational kinetic energy “KE” of the torque variance is calculated from the specifications of a particular pump, e.g., pump 300, and from empirical data taken from previous pump operations as shown in FIG. 2. For example, as shown in FIG. 2, the pressure spike P_{S} is analyzed to determine a magnitude of the pressure spike P_{S} and a duration of the pressure spike P_{S}. As shown, the duration of the pressure spike P_{S} occurred over 0.628 radians of the cycle and using the specification of the pump resulted in a torque above the nominal operating torque of 1420 lb-ft. From these values and given the constant velocity of the particular pump of 152.4 radians/second, the “KE” of a torque variance resulting from the pressure spike P_{S} may be calculated as 8922 lb-ft or 12,097 N-m of work.

The “KE” of the torque variance may be used to size a flywheel 22 such that the flywheel 22 has a “KE” greater than or equal to the “KE” of the torque variance. Initially, equation (1) is used to calculate a desired moment of inertia “I” of the flywheel 22 solving for the “KE” of the torque variance created by the pressure spike P_{S} for a given angular velocity “ω” of the flywheel 22. For example, the angular velocity “ω” of the output shaft 110 may be 152.4 radians/second with the “KE” of the torque variance created by the pressure spike P_{S} being 12,097 N-m. Solving equation (1) provides a desired moment of inertia “I” of the flywheel 22 as 1.047 kg m².

Once the desired moment of inertia “I” of the flywheel 22 is determined, equation (2) is used to determine dimensions of the flywheel 22 using desired moment of inertia “I”. As shown in FIG. 4, with the desired moment of inertia “I”, a set radius of rotation “r₁”, and a set thickness of the flywheel 22, the flywheel radius “r₂” and mass “m” may be manipulated such that the flywheel 22 has dimensions and a mass that are optimized for a particular application. Referring to FIG. 4, for example and not meant to be limiting, a 10 kg flywheel with an outer radius “r₂” of 0.45 m has the same moment of inertia as a 100 kg flywheel with an outer radius “r₂” of 0.13 m such that either the 10 kg flywheel or the 100 kg flywheel would have the same “KE” to absorb the “KE” of the torque variance created by the pressure spike P_{S}.

It will be appreciated that for a given system, the radius of rotation “r₁” of the flywheel is set by a diameter of the spindle or flange on which the flywheel is secured, e.g., upstream flange of the upstream portion 210 or the flange 242 or the spindle 244 of the downstream portion 240 (FIG. 1). In addition, the thickness “h” of the flywheel 22 may also be manipulated to vary a mass of the flywheel for a given outer radius “r₂”.

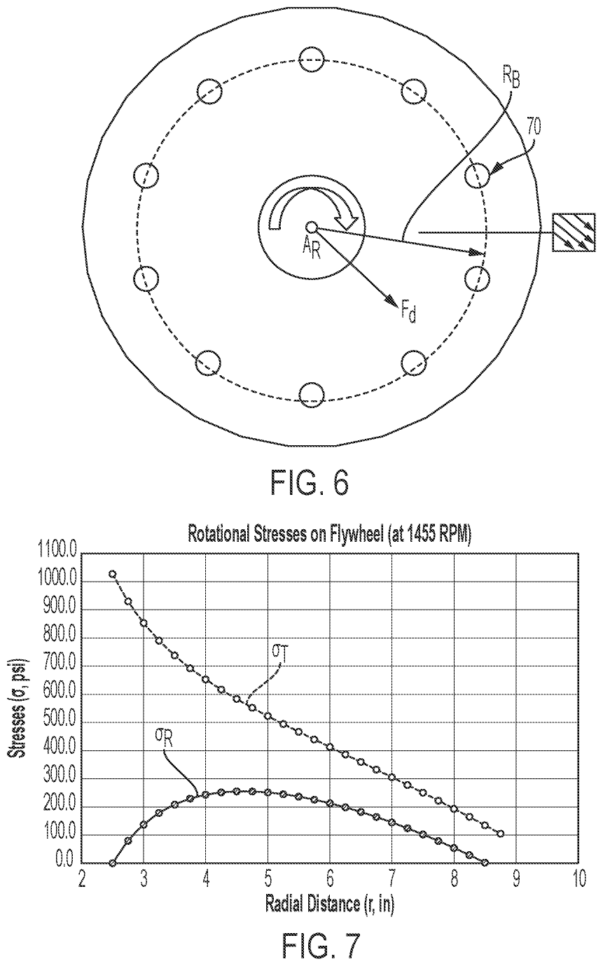

With additional reference to FIG. 6, the flywheel 22 is subjected to rotational stresses that differ within the flywheel 22 dependent on the radial distance “r_{d}” away from axis of rotation “A_{R}” of the flywheel 22. It is important to choose a material for the flywheel 22 that is capable of withstanding the rotational stresses of the flywheel 22. To determine the rotational stresses of the flywheel 22, the flywheel may be treated as a thick-walled cylinder to calculate the tangential and radial stresses thereof. The calculations detailed below assume that the flywheel 22 has a uniform thickness “h”, the flywheel radius “r₂” is substantially larger than the thickness “h” (e.g., r₂>5 h), and the stresses are constant over the thickness “h”. The tangential stress “αₜ” and radial stress “αᵣ” of the flywheel 22 may be expressed as follows:

$${σ}_{t} = ρ {ω}^{2} ( \frac{3 + v}{8} ) \{ {r}_{1}^{2} + {r}_{2}^{2} + \frac{{r}_{1}^{2} ( {r}_{2}^{2} )}{{r}_{d}^{2}} - \frac{( 1 + 3 v )}{3 + v} ( {r}_{d}^{2} ) \} \qquad ( 3 )$$

$${σ}_{r} = ρ {ω}^{2} ( \frac{3 + v}{8} ) \{ {r}_{1}^{2} + {r}_{2}^{2} - \frac{{r}_{1}^{2} ( {r}_{2}^{2} )}{{r}_{d}^{2}} - ( {r}_{d}^{2} ) \} \qquad ( 4 )$$

where ρ is a mass density (lb./in³) of the material of the flywheel 22, w is the angular velocity (rad/s) of the flywheel 22, and v is the Poisson's ratio of the flywheel 22. As shown in FIG. 7, when the inner radius r₁ is 2.5 inches and the outer radius r₂ is 8.52 inches the maximum tangential stress “αₜ” is 1027 psi at 2.5 inches from the axis of rotation and the maximum radial stress “αᵣ” is 255 psi at 4.5 inches from the axis of rotation.

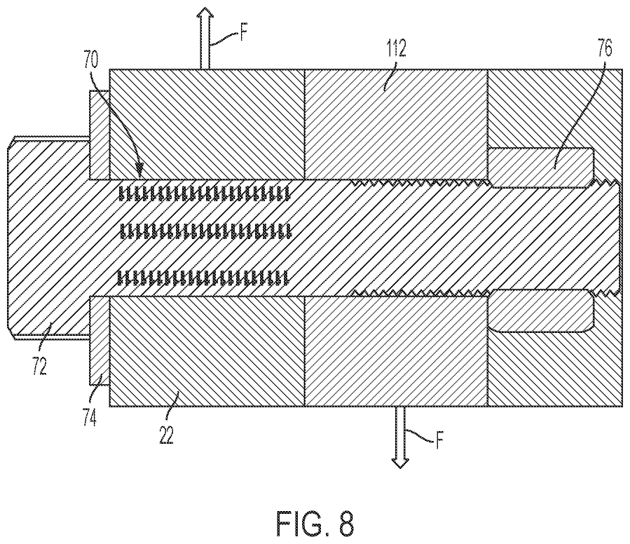

The installation or securement of the flywheel 22 to the pump system, e.g., to output flange 112 of the output shaft 110 (FIG. 1), must also be analyzed to confirm that the means for attachment is suitable for the calculated stresses. For example, the planar stresses occurring at the point of installment may be calculated. Specifically, the flywheel 22 may be installed to the output flange 112 as described above or to the input flange of the pump as described below. For the purposes of this analysis, it will be assumed that the flywheel 22 is installed with a number of bolts 72 and nuts 76 as shown in FIG. 8. To secure the flywheel 22 to the output flange 112 (FIG. 1), each bolt 72 is passed through a bolt hole 70 defined through the flywheel 22 at a bolt radius “re” (FIG. 6) from the axis of rotation “A_{R}” of the flywheel 22. The planar stresses may be calculated as follows:

$${F}_{B} = \frac{T}{{r}_{B}} \qquad ( 5 )$$

$${v}_{s} = \frac{T}{{A}_{B}} \qquad ( 6 )$$

$${v}_{b} = \frac{{F}_{8}}{h d} \qquad ( 7 )$$

where F_{B} is a force (lbf) applied to the bolt 72, T is a torque (lb-ft) applied to the flywheel 22, A_{B} is a bolt bearing stress area (in²) of the bolt 72, d is a diameter (ft) of the bolt hole 70, v_{S} is a shear stress (psi) of each bolt 72, and v_{b} is a bearing stress on the flywheel 22/bolt hole 70 (psi).

Continuing the example above, given a maximum torque “T” applied to the output flange 112 of 35,750 lb-ft with a bolt radius “re” of 7.6 inches, the force applied to the bolts F_{B} is 56,447 lbf. With the bolt bearing area of each bolt 72 being 0.785 in² the shear stress v_{S} of each of the 10 bolts is 7,187 psi. With the thickness of the flywheel “h” being 1.54 inches and a diameter of each bolt hole being 1.06 inches, the bearing stress v_{B} is 3,885 psi.

From the calculated stresses of the example above and applying a factor of safety, a material for the flywheel 22 should have should have a tensile yield strength greater than or equal to 75 ksi. Examples of some suitable materials for the flywheel 22 are 1040 carbon steel, 1050 carbon steel, or Inconel® 718; however, other suitable metals or other materials may also be used. In addition, the materials sued for the bolts 72 and the nuts 76 should have a tensile strength greater than the calculated stresses. Examples of some suitable materials for the bolts 72 and the nuts 76 are Grade 8 carbon steel, Grade 5 carbon steel, or Grade G (8) steel; however, other suitable metals or other materials may also be used.

Referring briefly back to FIG. 1, the vibration dampening assembly 10 may also include at least one torsional vibration damper. The at least one torsional vibration damper may comprise a torsional vibration damper 24 disposed upstream of the pump 300. As shown, the torsional vibration damper 24 is disposed about the upstream portion 210 of the driveshaft 210 and is connected to a downstream side of the flywheel 22. The vibration damper 24 may be connected directly to the flywheel 22 or directly to the output flange 112 of the driving equipment 100 and may be disposed about the upstream portion 210 of the driveshaft 210 or the output shaft 110. The torsional vibration damper 24 is configured to prevent torsional resonance within the driving equipment 100 that may lead to damage or fatigue of components of the driving equipment 100, the driveshaft 200, or the pump 300. Incorporation of the torsional vibration damper 24 along the drivetrain in between the gearbox and/or transmission and the single acting reciprocating pump 300 allows for the vibration dampening assembly 10 to dampen the high frequency, low amplitude torsional vibrations imposed on the drivetrain system that is caused by forced excitations from the synchronous machinery. The torsional vibration damper 24 may be a viscous, a spring-viscous, or a spring torsional vibration damper. Examples of suitable torsional vibration dampers include, but are not limited to, a Geislinger Damper, a Geislinger Vdamp®, a Metaldyne Viscous Damper, a Kendrion Torsional Vibration Dampener, a Riverhawk Torsional Vibration Dampener, and the like.

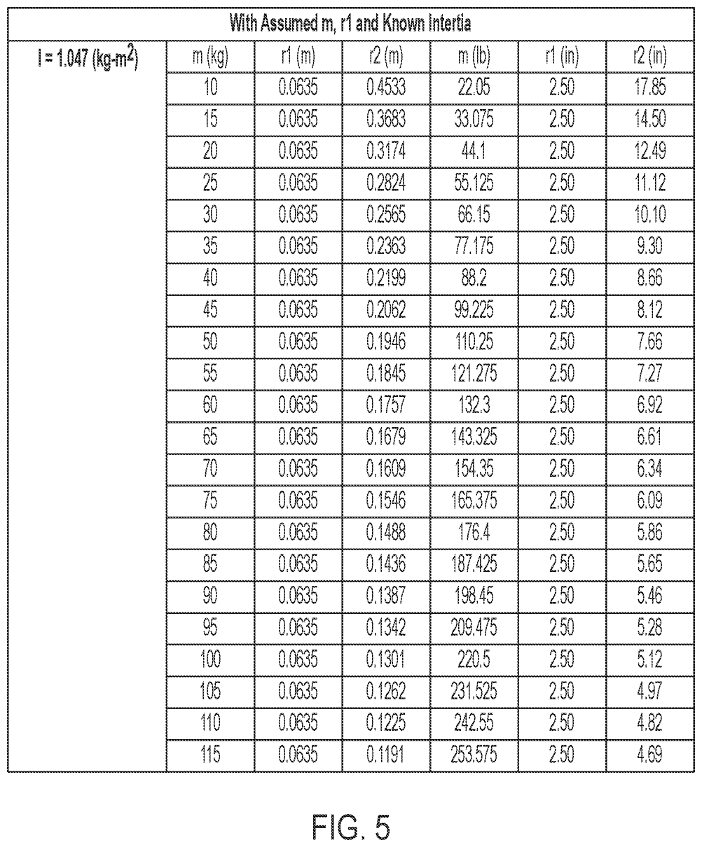

As shown FIG. 1, the vibration dampening assembly 10 is secured to the output flange 112. Specifically, the flywheel 22 is connected to the output flange 112 and the torsional vibration damper 24 is connected to the flywheel 22. However, as illustrated below with reference to FIGS. 5-7, the flywheel 22 and/or the torsional vibration damper 24 may be disposed at other positions within the pump system 1 and the vibration dampening assembly 10 may include multiple flywheels and/or multiple vibration dampers.

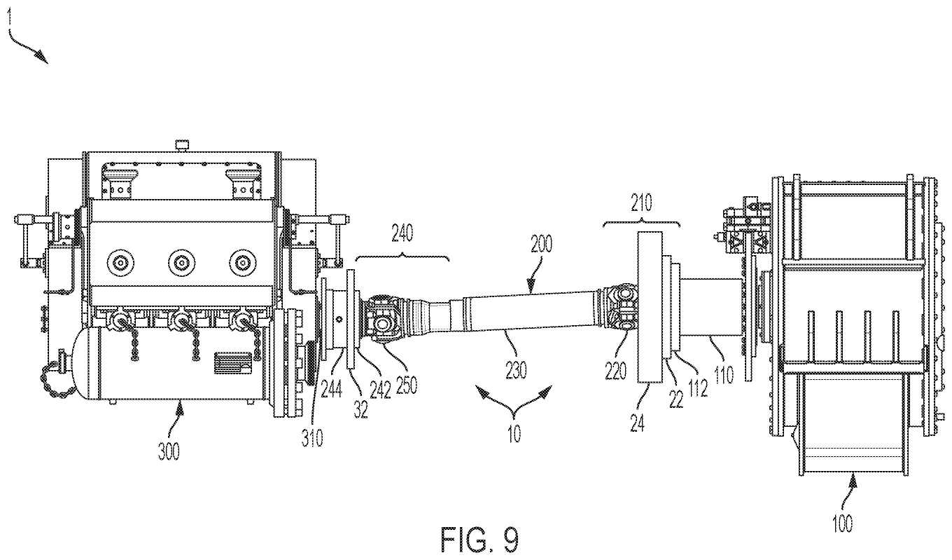

Referring now to FIG. 9, the vibration dampening assembly 10 includes a first flywheel 22, the torsional vibration damper 24, and a second flywheel 32. The second flywheel 32 is connected to the input flange of the pump 300. When the vibration dampening assembly 10 includes the first flywheel 22 and the second flywheel 32, the sum of the “KE” of the flywheels 22, 32 may be configured in a manner similar to the “KE” of a single flywheel as detailed above with respect to the flywheel 22. In some embodiments, each of the first and second flywheel 22, 32 is sized to have a similar moment of inertia “I”. In such embodiments, the first and second flywheel 22, 32 may have similar dimensions and mass or may have different dimensions and mass while having a similar moment of inertia “I”. In other embodiments, the first flywheel 22 is configured to have a moment of inertia “I” different, e.g., greater than or lesser than, a moment of inertia “I” of the second flywheel 32.

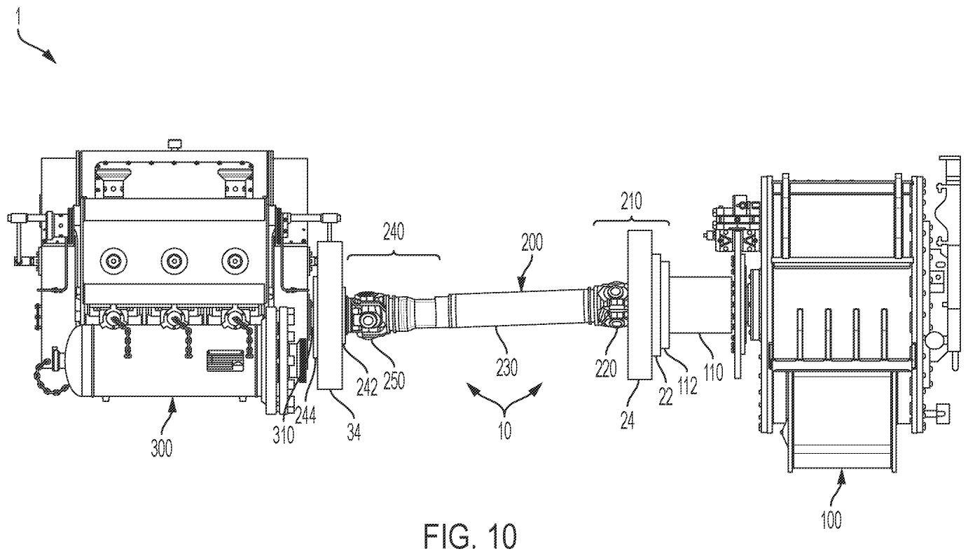

With reference to FIG. 10, the vibration dampening assembly 10 includes the flywheel 22, a first torsional vibration damper 24, and a second vibration damper 34. The flywheel 22 is connected to the output flange 112 of the driving equipment 100 and the first torsional vibration damper 24 is connected to the flywheel 22. The second vibration damper 34 is connected to the input flange of the pump 300. Using first and second vibration dampers 24, 34 instead of a single vibration damper may allow for greater resistance to torsional resonance within the driving equipment 100 and/or for each of the first and second vibration dampers 24, 34 to have a reduced size compared to a single vibration damper.

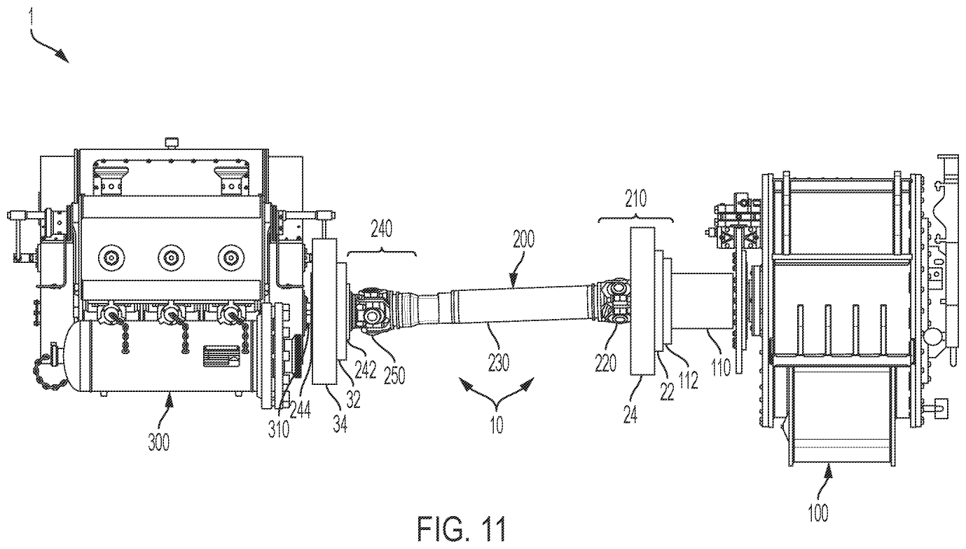

Referring now to FIG. 11, the vibration dampening assembly 10 includes the first flywheel 22, the first torsional vibration damper 24, the second flywheel 32, and the second vibration damper 34. The first flywheel 22 is connected to the output flange 122 of the driving equipment 100 with the first torsional vibration damper 24 connected to the first flywheel 22. The second flywheel 32 is connected to the input flange of the pump 300 with the second torsional vibration damper 34 connected to the second flywheel 32. As noted above, the first and second flywheels 22, 32 may be sized such that the sum of the “KE” of the flywheels 22, 32 is configured in a manner similar to the “KE” of a single flywheel detailed above with respect to the flywheel 22. In addition, using first and second vibration dampers 24, 34 instead of a single vibration damper which may allow for greater resistance to torsional resonance within the driving equipment 100.

The configurations of the vibration dampening assembly 10 detailed above should be seen as exemplary and not exhaustive of all the configurations of the vibration dampening assembly 10. For example, the vibration dampening assembly 10 may consist of a flywheel 32 and a torsional vibration damper 34 as shown in FIG. 6. In addition, it is contemplated that the vibration dampening assembly 10 may include more than two flywheels or more than two torsional vibration dampers. Further, the vibration dampers may each be connected directly to a respective flange, e.g., output flange 112 or input flange, and not be directly connected to a flywheel, e.g., flywheels 22, 32.

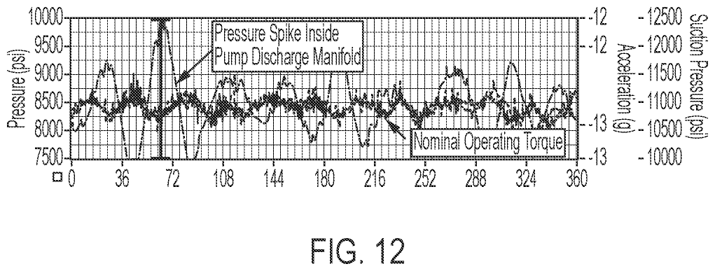

FIG. 12 is a graph showing torsional vibration analysis data results demonstrating the reduction in synthesis and torque spikes with the use of a torsional vibration dampener (TVD) and a single mass produced by a pump system such as shown in FIG. 1 according to an embodiment of the disclosure. A significant reduction in amplitude and frequency of the system torque spikes is noticeable over entire speed range of the reciprocating pump.

This is a continuation of U.S. Non-Provisional application Ser. No. 18/108,821, filed Feb. 13, 2023, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” which is a continuation of U.S. Non-Provisional application Ser. No. 17/585,766, filed Jan. 27, 2022, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” which is a continuation of U.S. Non-Provisional application Ser. No. 17/469,970, filed Sep. 9, 2021, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” now U.S. Pat. No. 11,280,331, issued Mar. 22, 2022, which is a continuation of U.S. Non-Provisional application Ser. No. 17/363,151, filed Jun. 30, 2021, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” now U.S. Pat. No. 11,149,726, issued Oct. 19, 2021, which is a continuation of U.S. Non-Provisional application Ser. No. 17/213,562, filed Mar. 26, 2021, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” now U.S. Pat. No. 11,092,152, issued Aug. 17, 2021, which is a continuation of U.S. Non-Provisional application Ser. No. 16/948,291, filed Sep. 11, 2020, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” now U.S. Pat. No. 11,015,594, issued May 25, 2021, which claims priority to and the benefit of U.S. Provisional Application No. 62/704,560, filed May 15, 2020, titled “SYSTEMS AND METHOD FOR USE OF SINGLE MASS FLYWHEEL ALONGSIDE TORSIONAL VIBRATION DAMPER ASSEMBLY FOR SINGLE ACTING RECIPROCATING PUMP,” and U.S. Provisional Application No. 62/899,963, filed Sep. 13, 2019, titled “USE OF SINGLE MASS FLYWHEEL ALONGSIDE TORSIONAL VIBRATION DAMPER SYSTEM FOR SINGLE ACTING RECIPROCATING PUMP,” the disclosures of which are incorporated herein by reference in their entireties.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A pump system comprising:
a pump having an input shaft, the input shaft having an input flange positioned to rotate about a longitudinal axis of the input shaft, the pump comprises a single acting reciprocating pump;
a driveshaft connected to the input shaft of the single acting reciprocating pump, the driveshaft having a longitudinal axis offset from the longitudinal axis of the input shaft;
driving equipment including:
a turbine engine;
a gearbox connected to the turbine engine; and
an output shaft connected to the gearbox, the output shaft having an output flange connected to the driveshaft, the output shaft configured to rotate the driveshaft to rotate the input shaft of the single acting reciprocating pump, the longitudinal axis of the driveshaft residing along a plane extending through the single acting reciprocating pump and the gearbox.

2. The pump system according to claim 1, further comprising a vibration dampening assembly including one or more torsional vibration dampers operably connected to the input shaft and configured to reduce torsional resonance within the driving equipment or the single acting reciprocating pump.

3. The pump system according to claim 1, wherein the input shaft includes an input flange connected to the driveshaft.

4. The pump system according to claim 2, wherein the one or more torsional vibration dampers comprise a first torsional vibration damper operably connected to the input shaft.

5. The pump system according to claim 4, wherein the input shaft includes an input flange connected to the driveshaft, the first torsional vibration damper being connected to the input flange.

6. The pump system according to claim 4, wherein the first torsional vibration damper is connected to the output flange.

7. The pump system according to claim 4, wherein the one or more torsional vibration dampers further comprises a second torsional vibration damper, wherein the input shaft includes an input flange connected to the driveshaft, the second torsional vibration damper being connected to the input flange.

8. The pump system according to claim 1, further comprising one or more single mass flywheels including a first flywheel operably connected to the input shaft and configured to rotate therewith, the one or more flywheels, including the first flywheel, also being configured to absorb a torque shock in the form of torque variance resulting from hydraulic fluid pulsation within the single acting reciprocating pump.

9. A pump system comprising:
a pump comprising a single acting reciprocating pump configured to pump a hydraulic fracturing fluid, the single acting reciprocating pump having an input shaft, the input shaft including an input flange and having a longitudinal axis;
a driveshaft connected to the input flange of the input shaft of the single acting reciprocating pump, the driveshaft having a longitudinal axis offset from the longitudinal axis of the input shaft; and
driving equipment including:
a turbine engine; and
a gearbox connected to the turbine engine, the gearbox comprising an output shaft and a brake, the output shaft having an output flange connected to the driveshaft and configured to rotate the driveshaft to rotate the input shaft of the single acting reciprocating pump,
wherein the longitudinal axis of the driveshaft resides along a plane extending through the single acting reciprocating pump and the gearbox.

10. The pump system according to claim 9, further comprising a torsional vibration damper operably connected to the input shaft, the torsional vibration damper being configured to reduce high frequency/low amplitude torsional vibrations generated by operation of the single acting reciprocating pump, wherein the torsional vibration damper comprises a viscous vibration damper, a spring-viscous vibration damper, or a spring torsional vibration damper.

11. The pump system according to claim 10, wherein the torsional vibration damper is connected to the output flange.

12. The pump system according to claim 10, wherein the torsional vibration damper comprises a first torsional vibration damper, and the pump system further comprises a second torsional vibration damper.

13. The pump system according to claim 12, wherein the input flange is connected to the driveshaft and the second torsional vibration damper, and wherein the second torsional vibration damper is disposed between the input flange and the driveshaft.

14. The pump system according to claim 13, wherein the first torsional vibration damper is connected to the output flange and the driveshaft, and wherein the first torsional vibration damper is disposed between the output flange and the driveshaft.

15. The pump system according to claim 9, wherein the driveshaft comprises an upstream portion, a downstream portion, and a central portion disposed between the upstream portion and the downstream portion, and wherein the upstream portion comprises a first constant velocity (CV) joint and the downstream portion comprises a second CV joint.

16. The pump system according to claim 9, further comprising one or more single mass flywheels including a first flywheel operably connected to the input shaft and configured to rotate therewith, the one or more flywheels, including the first flywheel, also being configured to absorb a torque shock in the form of torque variance resulting from hydraulic fracturing fluid pulsation within the single acting reciprocating pump.

17. A hydraulic fracturing pump system comprising:
a pump comprising a single acting reciprocating pump configured to pump hydraulic fracturing fluid, the single acting reciprocating pump having an input shaft, the input shaft including an input flange and having a longitudinal axis;
a driveshaft connected to the input flange of the input shaft of the single acting reciprocating pump, the driveshaft comprising:
an upstream portion comprising a first constant velocity (CV) joint,
a downstream portion comprising a second CV joint, and
a central portion disposed between the upstream portion and the downstream portion,
the driveshaft having a longitudinal axis offset from the longitudinal axis of the input shaft;
driving equipment including an output shaft having an output flange connected to the driveshaft and configured to rotate the driveshaft to rotate the input shaft of the pump therewith, the driving equipment comprising:
a gas turbine engine;
a gearbox directly connected to the gas turbine engine, the gearbox including an output shaft having an output flange connected to the driveshaft and configured to rotate the driveshaft to rotate the input shaft of the single acting reciprocating pump;
a brake rotor connected to the output shaft; and
a brake caliper connected to the gearbox,
wherein the longitudinal axis of the driveshaft resides along a plane extending through the single acting reciprocating pump and the gearbox.

18. The hydraulic fracturing pump system according to claim 17, further comprising a first torsional vibration damper operable connected to the first CV joint and disposed between the output flange and the first CV joint, the first torsional vibration damper configured to reduce high frequency/low amplitude torsional vibrations generated by operation of the single acting reciprocating pump.

19. The hydraulic fracturing pump system according to claim 18, further comprising a second torsional vibration damper, the second vibration damper connected to the input flange and the second CV joint, wherein the second vibration damper is disposed between the input flange and the second CV joint, wherein the first torsional vibration damper and the second torsional vibration damper comprises one or more of a viscous vibration damper, a spring-viscous vibration damper, or a spring torsional vibration damper.

20. The hydraulic fracturing pump system according to claim 18, further comprising one or more single mass flywheels including a first flywheel operably connected to the input shaft and configured to rotate therewith, the one or more flywheels, including the first flywheel, also being configured to absorb a torque shock in the form of torque variance resulting from hydraulic fracturing fluid pulsation within the single acting reciprocating pump.
